(19) United States
(12) Patent Application Publication
(10) Pub. No.: US 2020/0218347 A1
(43) Pub. Date: Jul. 9, 2020

(54) CONTROL SYSTEM, VEHICLE AND METHOD FOR CONTROLLING MULTIPLE FACILITIES

(71) Applicants: Yu-Sian Jiang, Austin, TX (US); Mu-Jen Huang, Taipei (TW)

(72) Inventors: Yu-Sian Jiang, Austin, TX (US); Mu-Jen Huang, Taipei (TW)

(21) Appl. No.: 16/735,693

(22) Filed: Jan. 6, 2020

Related U.S. Application Data
(60) Provisional application No. 62/788,942, filed on Jan. 6, 2019.

(51) Int. Cl. G06F 3/01; G06K 9/00; G02B 27/01; G02B 27/00

(52) U.S. Cl. CPC G06F 3/013; G06K 9/00281; G02B 2027/0187; G02B 27/0093; G02B 27/0179

(57) ABSTRACT

A control system is provided. The control system includes an image capturing unit, an input interface and a processing unit. The image capturing unit is configured to capture a plurality of images of a user. The input interface configured to receive an input signal from the user. The processing unit is configured to identify a facial feature from the captured images; calculate a gaze point of the user according to the facial feature; determine a target facility among multiple facilities according to the gaze point of the user; receive a confirmation signal; configure the target facility as a facility subject to control when the confirmation signal is received; and control the facility subject to control in response to a control signal received from the input interface.

### CROSS REFERENCE

This application claims the benefit and priority to of U.S. Provisional Application Ser. No. 62/788,942, filed on Jan. 6, 2019, and entitled “SYSTEM AND METHOD FOR CONTROLLING FACILITIES”, which is incorporated herein by reference in its entirety.

### FIELD

The present disclosure generally relates to a control system, a vehicle and a method for controlling multiple facilities.

### BACKGROUND

Modern vehicles equip with various facilities, such as air conditioners, infotainment, to make drivers and passengers comfortable and entertained. Additionally, other facilities, such as rear-view mirrors, are used to facilitate safe driving. Those facilities are usually managed independently. For example, the buttons or switches disposed on an air conditioner can only control the air conditioner. Similarly, equipment like rear-view mirrors, wipers, and infotainment systems all have its dedicated controller. If a driver intends to control or adjust one of the facilities, such control or adjustment can only be conducted through that particular buttons or switches.

Another issue regarding the conventional arrangement is that those controlling interface such as knob, buttons, or switches are disposed in various places in the vehicle cockpit. The driver has to change his/her position or lean his/her body in order to reach the related buttons or switches, which adds potential safety concerns. In one scenario, assuming a driver wants to increase the temperature setting in the vehicle, he/she may need to take several seconds to find the correct control in a dashboard, which is a distracted behavior during driving. Alternatively, if the controls are made through a single touch panel, they may be arranged in different menu and hierarchies. While the level of the controlling interface complexity increases, the driver is likely to be distracted more when he/she attempts to operate the controlling interface.

Several technologies, such as a voice control, or a gesture control, have been provided to overcome this issue. However, neither of them is ideal. Voice control techniques require a preamble before it can work properly, let alone the surrounding noises could affect the recognition rate or falsely turn on the voice assistance. As for gesture control, since the driver would have to keep at least one hand on the wheel when driving the vehicle, the instructions can only be given through a bare hand and thus it is limited.

SUMMARY

In one exemplary embodiment disclosed herein, a control system is provided. The control system includes an image capturing unit, an input interface, and a processing unit. The image capturing unit is configured to capture a plurality of images of a user. The input interface is configured to receive an input command from the user, and the processing unit is configured to recognize a facial feature from the captured images; calculate a gaze point of the user according to the facial feature; determine a target facility among multiple facilities according to the gaze point of the user; receive a confirmation signal; configure the target facility as a facility subject to control when the confirmation signal is received; and control the facility subject to control in response to a control signal received from the input interface.

In another exemplary embodiment disclosed herein, a method for controlling multiple facilities is provided. The method includes the following actions. The image capturing unit captures a plurality of images of a user. The processing unit identifies a facial feature from the captured images; calculates a gaze point of the user according to the facial feature; determines a target facility according to the gaze point of the user; receives a confirmation signal; configures the target facility as a facility subject to control when the confirmation signal is received; and controls the facility subject to control in response to a control signal received from the input interface.

In yet another exemplary embodiment disclosed herein, a vehicle is provided. The vehicle includes multiple facilities and a control system. The control system includes an image capturing unit, an input interface and a processing unit. The image capturing unit captures a plurality of images of a user. The processing unit recognizes a facial feature from the captured images; calculates a gaze point of the user according to the facial feature; determines a target facility according to the gaze point of the user; receives a confirmation signal; configures the target facility as a facility subject to control when the confirmation signal is received; and controls the facility subject to control in response to a control signal received from the input interface.

Additional features and advantages of the disclosed technology will be made apparent from the following detailed description of embodiments that proceeds with reference to the accompanying drawings.

### BRIEF DESCRIPTION OF THE DRAWINGS

FIG. 1 is a block diagram of a control system according to an implementation of the present disclosure.

FIG. 2 is a flowchart of a method for controlling multiple facilities according to an embodiment of the present disclosure.

FIG. 3A is a schematic diagram showing the position of a target facility.

FIG. 3B is a schematic diagram of a captured image.

FIG. 4A is a schematic diagram illustrating a gaze point obtained based on the user's eye vectors according to an implementation of the present disclosure.

FIG. 4B is a schematic diagram illustrating a gaze point obtained based on a gaze vector according to another implementation of the present disclosure.

FIG. 5A is a schematic diagram showing a determination of the target facility based on the gaze point according to an implementation of the present disclosure.

FIG. 5B is a schematic diagram showing a determination of the target facility based on the gaze point according to an implementation of the present disclosure.

FIG. 6A is a schematic diagram showing an operational zone of a target facility according to an implementation of the present disclosure.

FIG. 6B illustrates a schematic diagram showing a determination of target facility by reference to an operational zone according to an implementation of the present disclosure.

FIGS. 7A-7D are schematic diagrams illustrating are schematic diagrams illustrating an implementation where a user in a vehicle tries to control the facilities inside the vehicle through the control system.

FIG. 8 is a schematic diagram showing the gaze point falls on or near the edge of more than one facility.

FIG. 9 is a schematic diagram illustrating a predictive path inferred based on the user's on-going positional/directional change of gaze.

FIG. 10 illustrates a scenario where multiple displays are controlled according to an implementation of the present disclosure.

FIG. 11 is a flowchart of a method for controlling multiple facilities according to an embodiment of the present disclosure.

### DETAILED DESCRIPTION

The following description contains specific information pertaining to exemplary implementations in the present disclosure. The drawings in the present disclosure and their accompanying detailed description are directed to merely exemplary implementations. However, the present disclosure is not limited to merely these exemplary implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale, and are not intended to correspond to actual relative dimensions.

In view of the foregoing, it is important to develop a system and a method for a user to control or adjust facilities in a non-distractive way; particularly when the user is operating a machine, e.g. a vehicle, which requires a hundred-percent concentration.

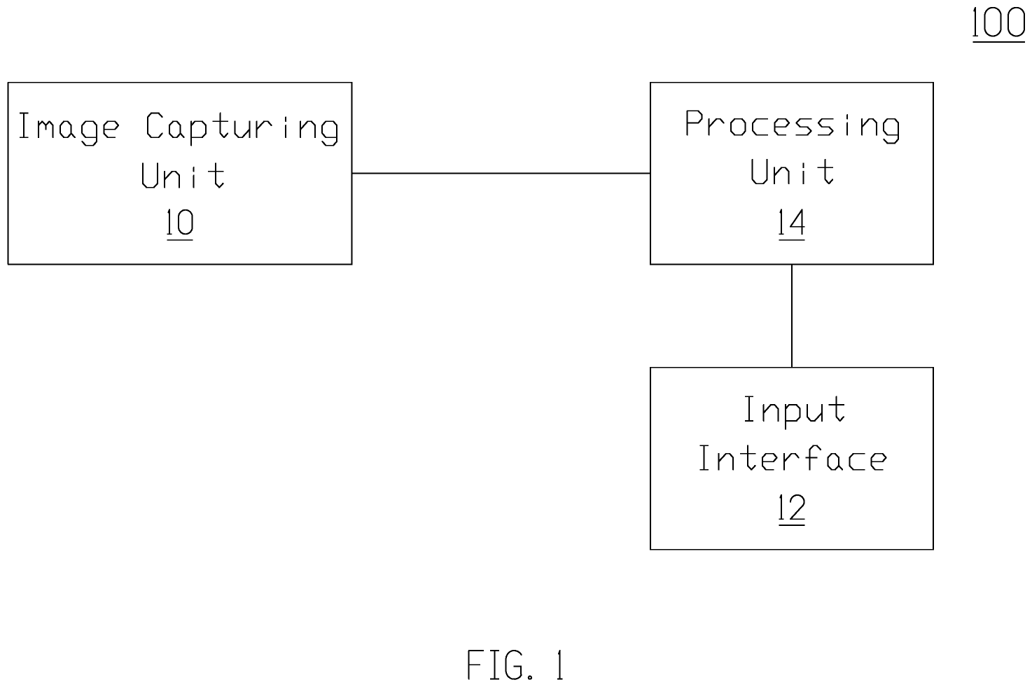

FIG. 1 illustrates a block diagram of a control system according to an implementation of the present disclosure. The control system 100 includes an image capturing unit 10, an input interface 12, and a processing unit 14.

The image capturing unit 10 is configured to capture images of a user. In one implementation, the image capturing unit 10 may be, but not limited to, one or more cameras or any device capable of capturing images. The image capturing unit 10 may be a depth-sensing camera with a depth sensor. The camera may be an RGB color camera or an infrared (IR) camera. In some embodiments, the image capturing unit 10 further includes a light source (e.g., an IR illuminator or a visible light illuminator) enabling instant profiling of the hand/face/head/body of the user. With the light source and high dynamic range (HDR) imaging, the object detection and biometric recognition may be adapted to a darker environment.

The input interface 12 is configured to receive an input signal from the user. The input interface 12 may be, but not limited to, a microphone to record the sound, voice or speech of the user, a button, a switch, a knob, a touch panel, a keyboard. In another embodiment, the input interface 12 is coupled to an electronic device to receive data or instructions. For instance, the electronic device may include, but not limited to, a tablet, a voice receiving/recognition device, a wearable device or a mobile device. Thus, the input interface 12 may receive various types of input signal via different kinds of input interface.

The processing unit 14 is coupled to the image capturing unit 10 and the input interface 12. The processing unit 14 may process data and instructions. In one embodiment, the processing unit 14 may be a hardware module comprising one or more central processing unit (CPU), microcontroller(s), ASIC, or a combination of above but is not limited thereof. The processing unit 14 may perform image recognition and image processing. In one embodiment, the processing unit 14 is configured to detect a face from the captured images. In some embodiment, the processing unit 14 detect the head pose and head position from the captured images. In some embodiments, the processing unit 14 detects the gaze vector and project the gaze vector to the 3D coordinate. In some embodiments, the processing unit 14 further performs facial recognition, voice recognition and other biometric recognition. In some embodiments, the processing unit 14 configures the facilities in response to the input signal or control signal received from the input interface 12.

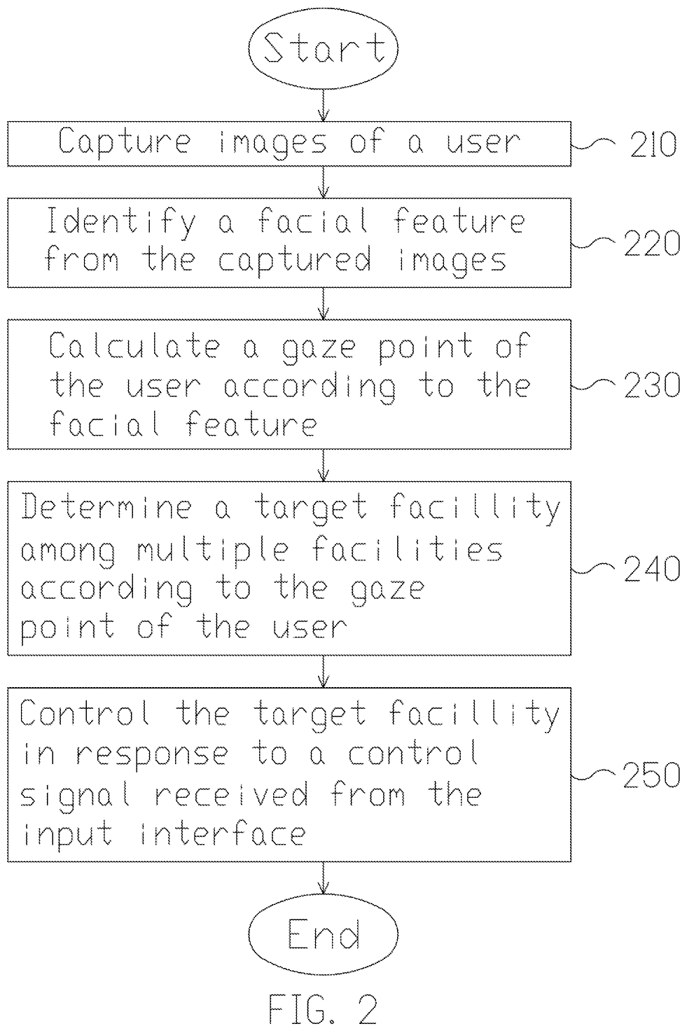

FIG. 2 is a flowchart of a method for controlling multiple facilities according to an embodiment of the present disclosure. The method includes the following actions. In action 210, the image capturing unit captures images of a user, wherein the images may contain a human face for further feature extractions. In action 220, the processing unit is coupled to the image capturing unit to recognize a facial feature from the captured images, wherein the facial features may include a face bounding box, a facial landmark, a head pose characterized by yaw, pitch, and row, a head location characterized by value of a 3D coordinate, a eyes status characterized by pupil and glint, gaze vector, etc. In action 230, the processing unit infers a gaze point of the user according to the facial features, wherein the gaze point is a projected point in the 3D coordinate system of user's eyes sight. The projected gaze point is dependent with the gaze vector, head pose, and the head position. In action 240, the processing unit determines a target facility among multiple facilities according to the gaze point of the user. The determination of the target facility may be done by correlating the gaze point and/or the gaze trajectory with the positions of facility. In action 250, the processing unit controls the target facility in response to a control signal received from the input interface.

The method will be described as follow based on a scenario where the control system 100 is installed in a vehicle. However, the present invention is not limited thereto. In another example, the control system 100 may also be equipped in a room having multiple facilities to be controlled. In one example, the control system 100 may be installed in a vehicle where various facilities, such as a instrument cluster, an air conditioner, an infotainment system, rearview mirrors, and wipers are installed and subject to users' command through the control system 100. The controls to the various facilities are all made through the input interface 12. One or more parts of the input interface may be arranged on the steering wheel, beside the seat, on the roof, near the dashboard or anywhere reachable by the user. To be able to control/adjust various types of facilities, the processing unit 14 may have different configurations to accommodate the facilities. Precisely, given the nature of the facility being subject to the user's control, the control system 100 changes the configurations of the processing unit 14 to adapt to the functions of the facility. For instance, when a first configuration is applied to control an infotainment device, the user may issue various control signals to control the infotainment device via the configured input interface 12. The control signals may include tune the channel, turn up/down the volume, streaming music, etc. A first control signal, e.g. a double click on a first button of an input interface 12 will trigger a first function of the infotainment. Similarly, if a second configuration is applied to control a rear mirror, the user may issue various control signals to control the rear mirror via the configured input interface 12. The control signal should be able to adjust the position of the rear mirror. The first control signal, e.g. a double click on the first button of the input interface 12 will trigger a first function of the rear mirror. Thus, the settings of the processing unit 14 should be able to conduct various types of controls via the control signals from the input interface 12.

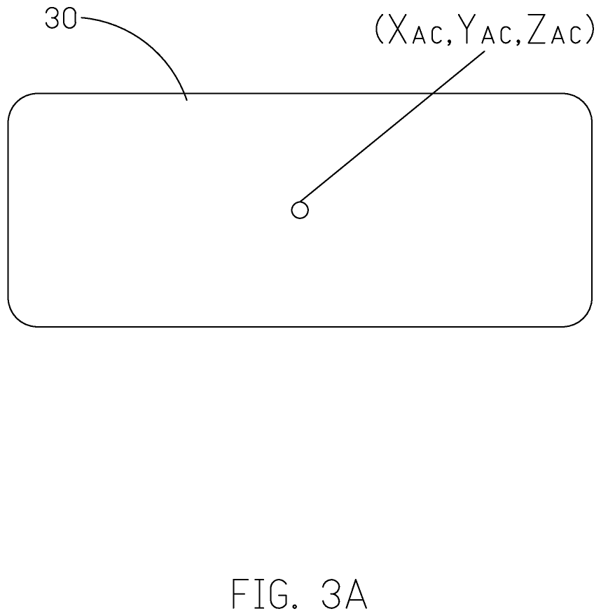

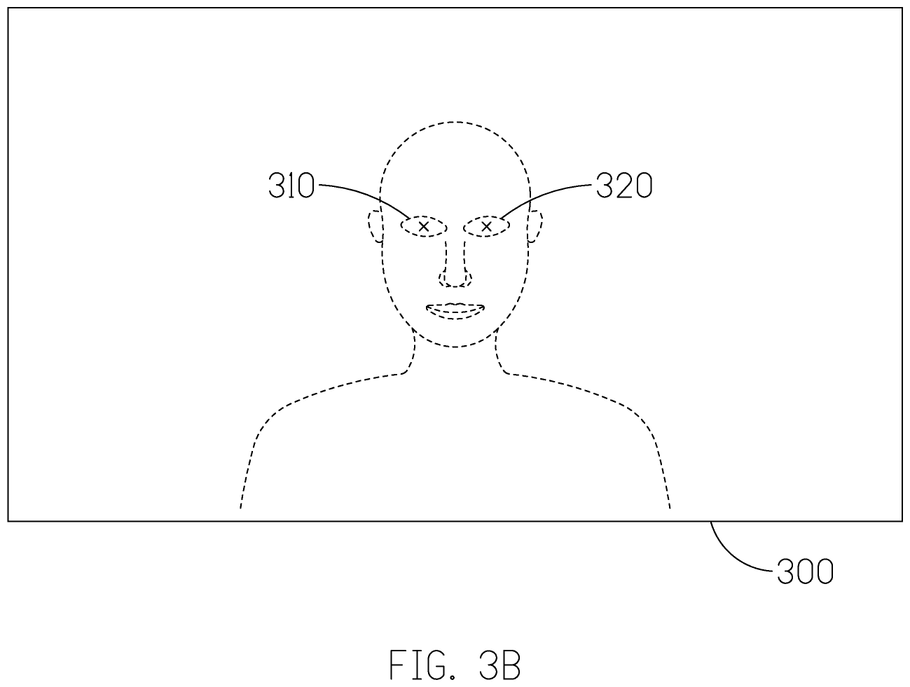

Inside a vehicle where the control system 100 is installed, a three-dimensional (3D) world coordinate system is established accordingly to locate the positions of a user and various facilities. The arbitrary point of the world coordinate system may be any dot inside the vehicle, preferably, a fixed point. Because the facilities are fixtures, their locations are ascertained in view of the world coordinate system. In one example, a location of a facility may be presented by the coordinate of the facility's reference point. The reference point may be any point on the facility; one typical example is its center point. FIG. 3A illustrates an example showing the location of an air conditioner installed in a vehicle. The location of the air conditioner 30 can be represented by the coordinate of, for instance, the center point, i.e. (XAC, YAC, ZAC). The coordinates of the facilities may be stored in a storage (not shown in the diagram) and will be referenced by the control system 100.

The operation of the control system 100 is disclosed as follows. To begin with, the image capturing unit 10 captures facial images of the user. The images should at least contain information of the user's eyes, so the image capturing unit 10 may be placed in the location where the necessary information can be conveniently obtained. In one example, the image capturing unit 10 is disposed right in front of the user when the user is facing directly straight. In any case, the position of the image capturing unit 10 is ascertained in view of the world coordinate system. Moreover, the image capturing unit 10 may capture the user's facial images continuously. Based on the continuously obtained images, the control system 100 can track the positional changes of the user's dynamic gaze point, i.e. the gaze trajectory, in real-time.

After the images of a user are captured by the image capturing unit 10, the processing unit 14 recognizes a facial feature of the user from the captured images. For instance, a face bounding box, an eye region, a head pose, a head position, a facial landmark, a gaze vector is recognized, and a gaze point is inferred and could be represented in light of the world coordinate system. As exampled in FIG. 3B, through image processing algorithms and perhaps volumes of training data familiar by those skilled persons, the user's eyes (e.g., 310 and 320) status and gaze vector are recognized according to the captured images 300. Since the depth between the camera and the user can be derived from the facial features, also the position of the image capturing unit 10 is known, once the user's eyes are spotted, the coordinates of the user's eyes and a gaze vector of the user could be obtained accordingly. Since the gaze vector indicates the user's viewing direction, the gaze point of the user could therefore obtained according to the user's position and the gaze vector. In another embodiment, the information of the user's head pose, nose tip, and other facial landmarks or features are used for inferring the gaze point of the user.

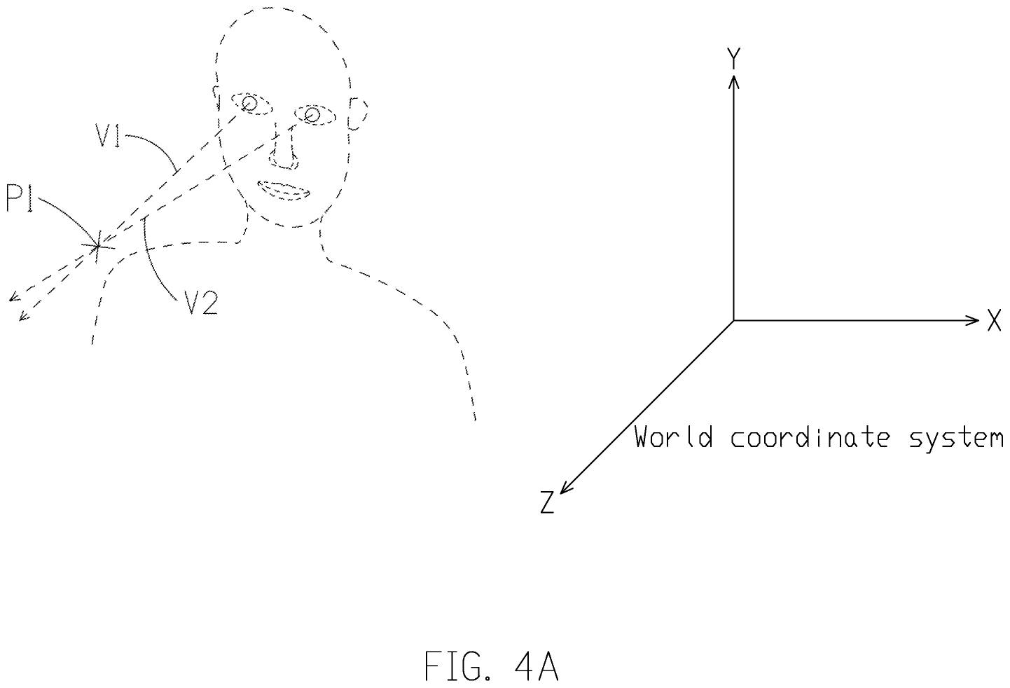

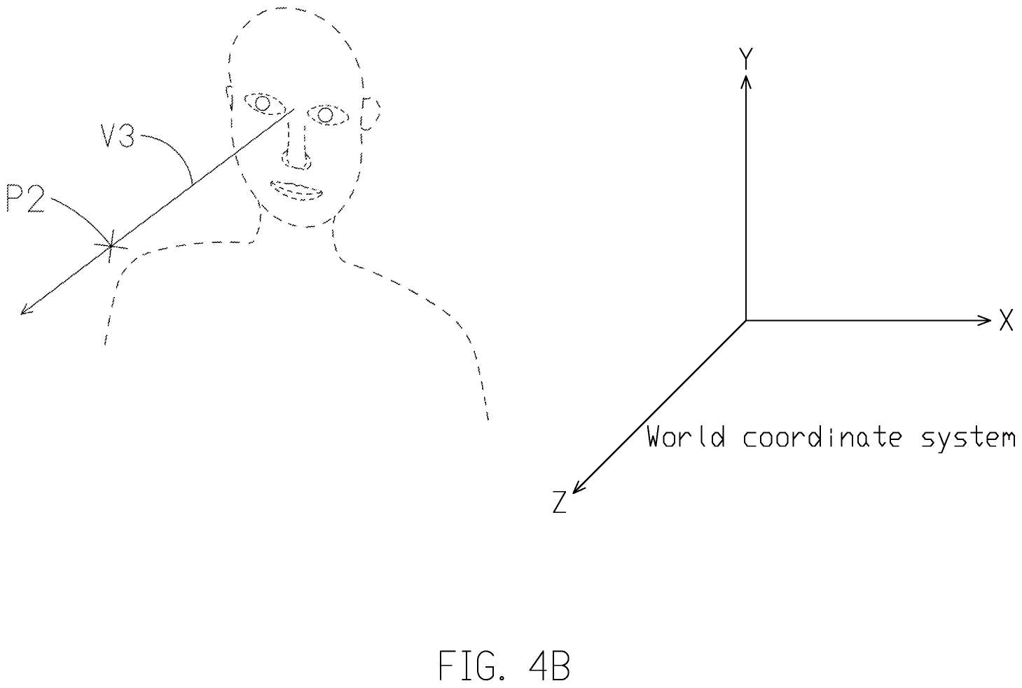

Afterwards, the processing unit may infer which facility that the user is looking at once the user's position, particularly, the positions of the user's eyes, is ascertained and determines it as the target facility. For example, the processing unit estimates a gaze point of the user according to the gaze vector, the position of the user, and the positions of the facilities, to determine whether the user is looking at one of the facilities. Plainly, the gaze point P1 is the point where the user's left-eye vector V1 (i.e. representing the viewing direction from the user's left-eye) and right-eye vector V2 (i.e. representing the viewing direction from the user's right-eye) come across, as depicted in FIG. 4A. In another embodiment as shown in FIG. 4B, the gaze point P2 is estimated based on the gaze vector V3. In one example, volumes of data where known various gaze points (the ground truth data) with respect to different face features are trained before hand, and the model is then loaded into the control system 100 for inferring the gaze point. In another embodiment, an end-to-end model is trained by the target facility classifier with respect to the features. Similarly, the model is to load onto the control system 100 for inferring the target facility. In some embodiment, the glint that characterized from the reflection point in the pupil with respect to the infrared illuminator is analyzed to detect the gaze vector, and in another embodiment that the glint becomes part of the features in the training algorithm. There are several techniques known to the skilled persons as to the determination of the gaze vector as well as the gaze point. The above are mere examples and should not constitute any limitations to the present invention.

If it is determined that the gaze point is on a target facility (e.g., their coordinates correlate), the processing unit configures the target facility as the facility subject to control. For example, a state of service signal may be issued to change the configurations of the input interface 12 or the processing unit 14 to adapt to the functions of the target facility. Consequently, the user may exercise the input interface 12 including buttons, switches, knobs, or a touch panel arranged somewhere nearby the user to command/control the target facility.

Alternatively, the input interface 12 may be coupled to a standalone controller such as a mobile device capable of controlling facilities. In such scenario, a communication link is established among the control system 100, the facilities and the standalone controller via a binding communication protocol, such as Wi-Fi, Bluetooth. In this way, the standalone controller, though is independent to the control system 100, can still be able to control the facilities through the communication link. In one embodiment, assuming the control is made through a mobile device, the user may even be able to cast contents, e.g. music, video, from the mobile device to the infotainment device via control signals or input signals which is under the user's control.

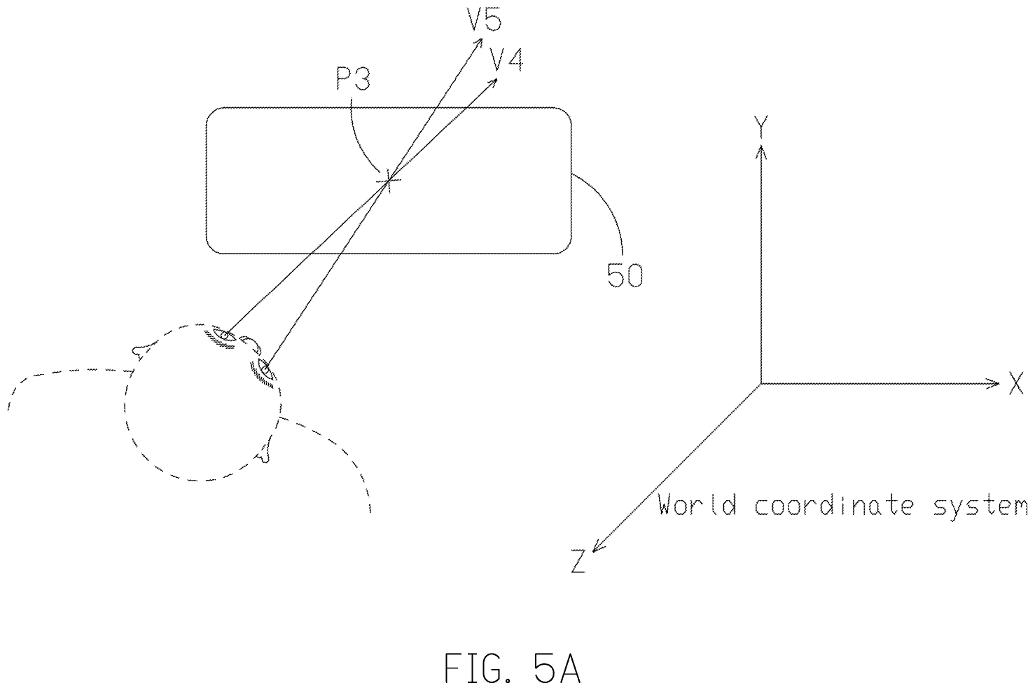

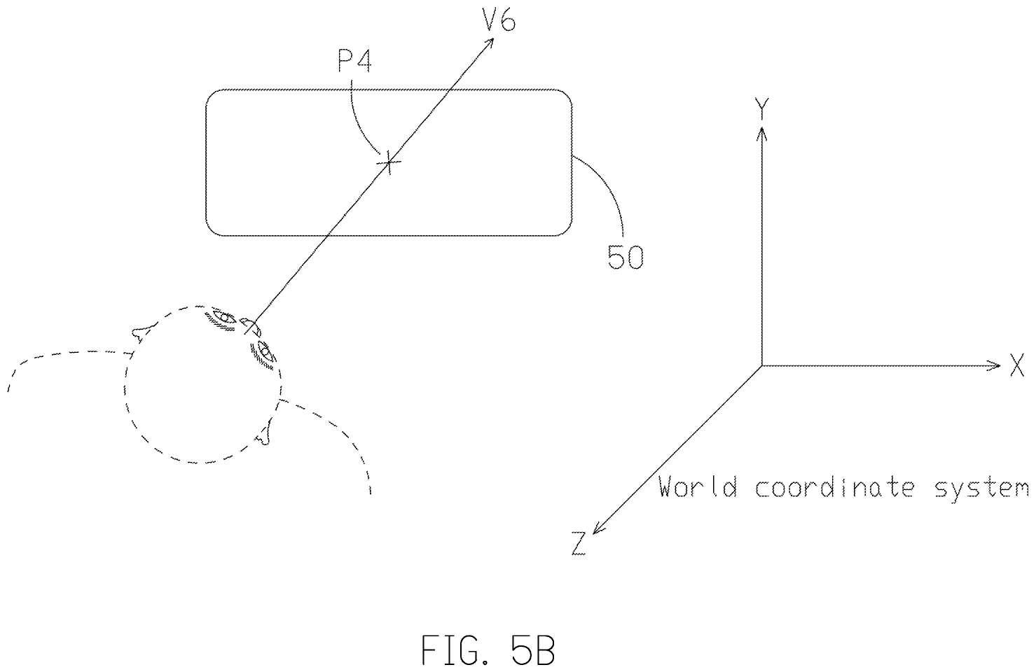

FIG. 5A is a schematic diagram showing a determination of the target facility based on the gaze point according to an implementation of the present disclosure. As shown in FIG. 5A, the gaze point P3 is determined based on the eye vectors V4 and V5. The processing unit 14 then determines whether the gaze point P3 correlates with the location of one of the facilities. For instance, when the processing unit 14 determines the gaze point P3 correlates with the location of the air conditioner 50, the air conditioner 50 is determined as the target facility and the configuration is made such that the user may control the air conditioner 50 through the input interface 12.

FIG. 5B is a schematic diagram showing a determination of the same based on the gaze point according to another implementation of the present disclosure. In this implementation, the gaze point P4 is determined based on the gaze vector V6. Regardless what approach is adopted, the processing unit 14 determines whether the gaze point P4 correlates with the location of one of the facilities. Once it is determined that the user's gaze point P4 is on the air conditioner 50, the processing unit 14 may determine the air conditioner 50 is the target facility and configure the input interface 12 such that user can then control the air conditioner 50 through the input interface 12. The current configurations of the input interface 12 are modified to provide controls. When a configuration is applied to control the air conditioner 50, the control signals may include, without limitation, turn on/off the air conditioner 50, increase/decrease the temperature or other controls applied to the air conditioner 50.

Additionally, those skilled persons would understand that all the variants including the coordinates of the user's, other facial landmarks such as the nose tip, the eyebrow, the lip, may also be considered as face features. to determine the user's gaze direction, head pose, viewing-angle, and therefore to conclude the gaze point. In some embodiments, the features for recognizing the gaze vector and gaze point may include the non-facial features such as the body skeleton. The above are mere examples without intending to limit the practices of the present invention.

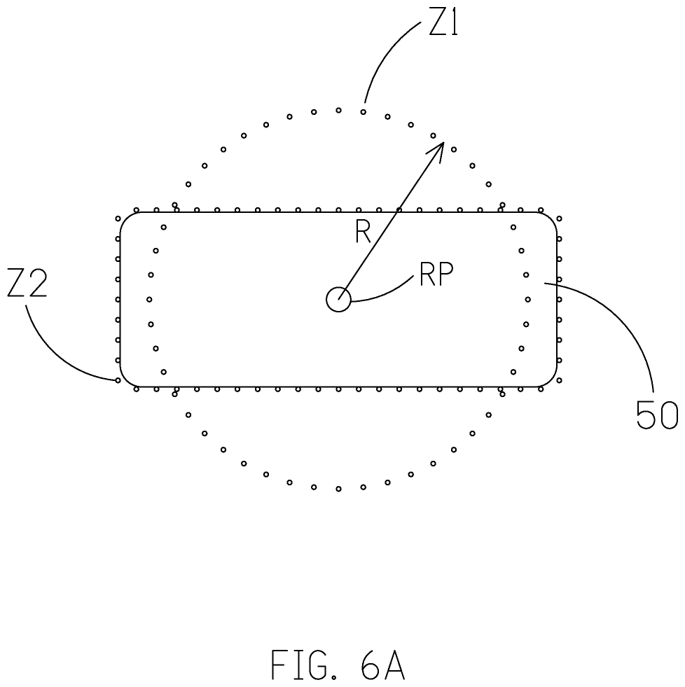

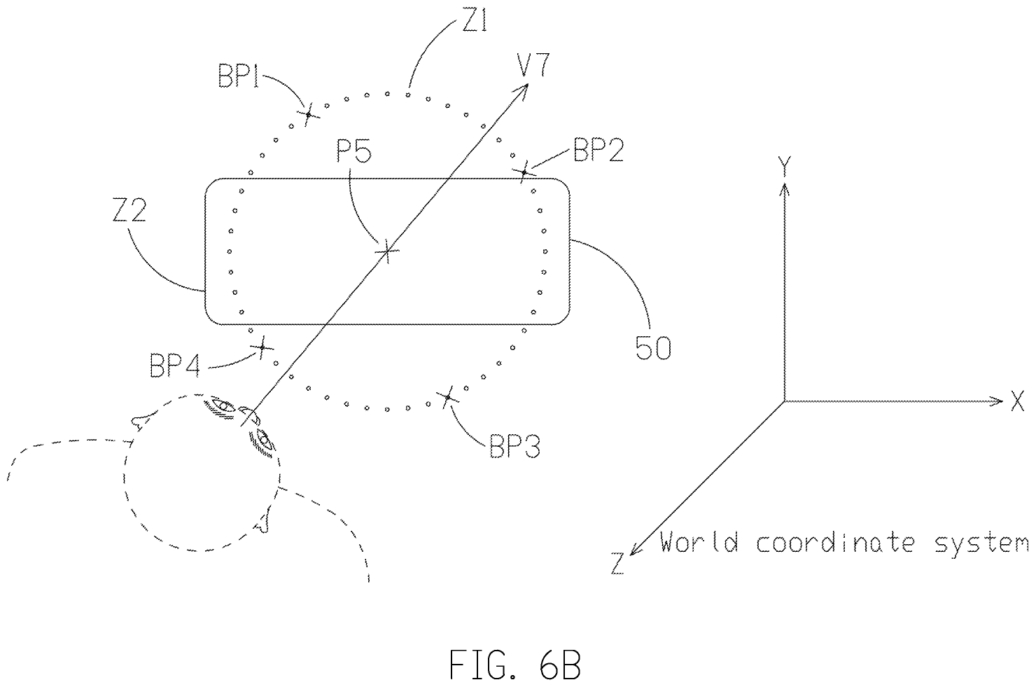

In another example of the present disclosure, every facility may have a predefined operational zone to determine whether the user stares at the facility. The operational zone is delineated by expanding a reference point of the facility outward to a certain distance, or it may be the boundary of the facility with or without a buffer space. If the processing unit 14 determines that the user's gaze point falls within the operational zones, the corresponding facility will then be subject to the user's control through the operation. In some embodiment, the control system 100 may adopt more than one manner in one occasion to define operational zones of the various facilities. Delineations of operational zones will be disclosed in detail by reference to FIG. 6A.

As exemplarily shown in FIG. 6A, the operational zone Z1 of the air conditioner 50 may be delineated by the scope circled by a radius R from a reference point RP, or by the boundary of air conditioner (e.g., Z2) with or without a buffer space (e.g., the dot-circled ranges in FIG. 6A). It should be noted that the reference point may be any point on the air conditioner 50. In the instant scenario as shown in FIG. 6A, the reference point RP is the center point. There may be other ways to define the scope of operational zones, the above are mere examples for demonstration purpose only. As mentioned, the control system 100 may adopt more than one manner in one occasion to define operational zones of the various facilities. That is, one facility which operational zone may be drawn with reference to its center; while another facility may have an operational zone defined by its boundary.

FIG. 6B illustrates a schematic diagram showing a determination of a target facility by reference to an operational zone in accordance with an implementation of the present disclosure. As disclosed, the processing unit 14 infers the gaze point P5 based on, for instance the gaze vector V7. The processing unit 14 then determine whether the gaze point P5 is within the operational zone (e.g., Z1 or Z2). In one embodiment, the processing unit 14 then determine whether the gaze point P5 is within the operational zone by reference to, for example, the four points, i.e. BP1, BP2, BP3, and BP4, from the edge of the operational zone. There are other ways to determine whether the gaze point P5 is within the operational zone, the above is provided for illustrative purposes only and should not constitute any limitations.

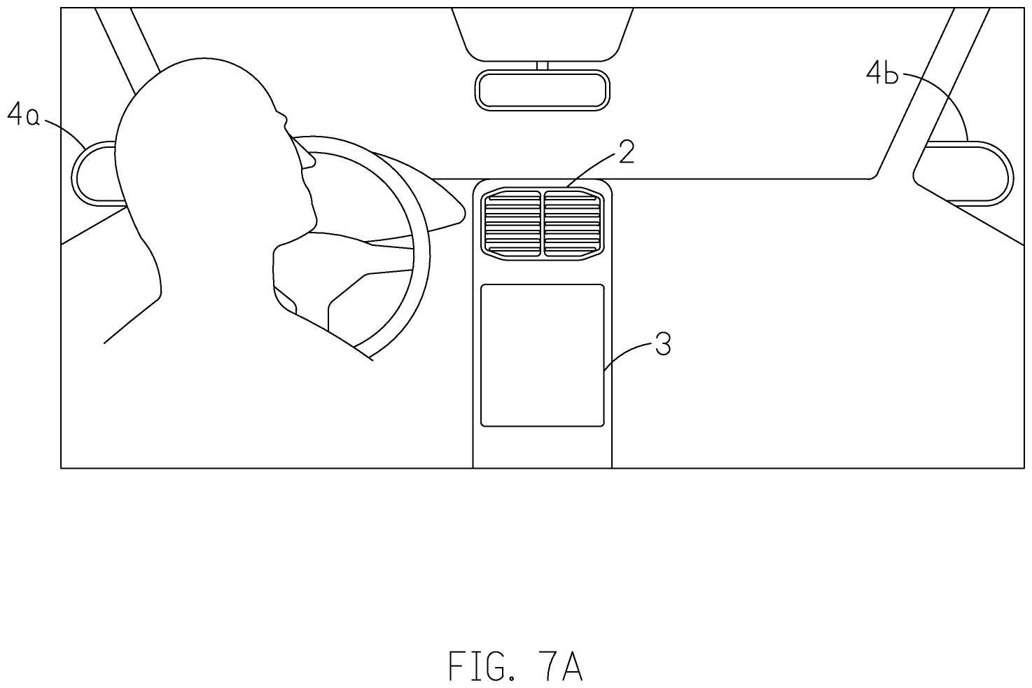

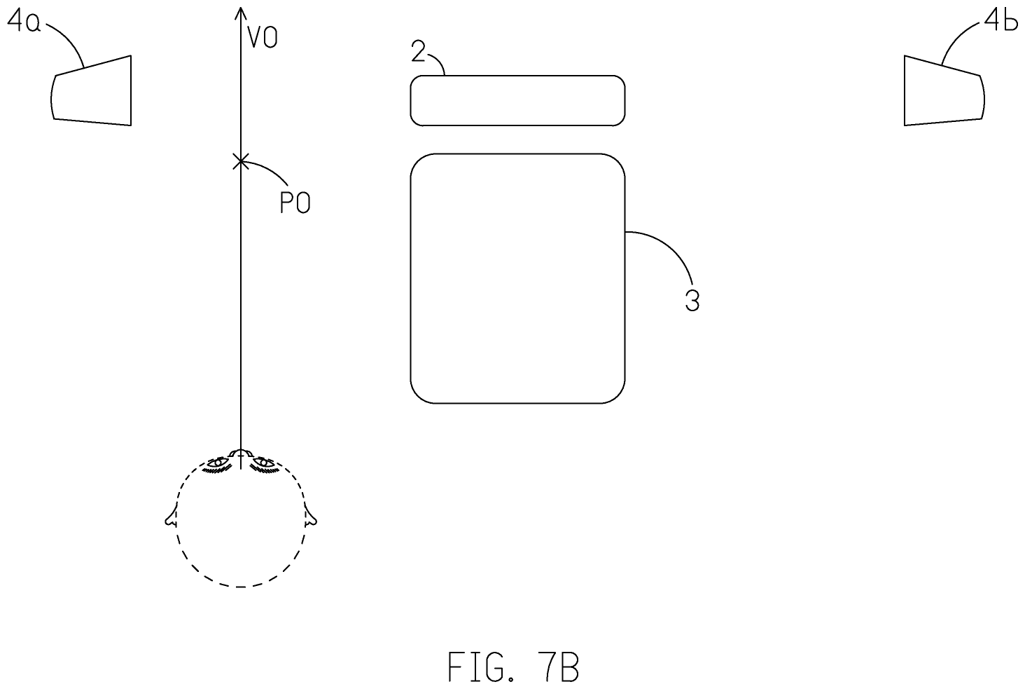

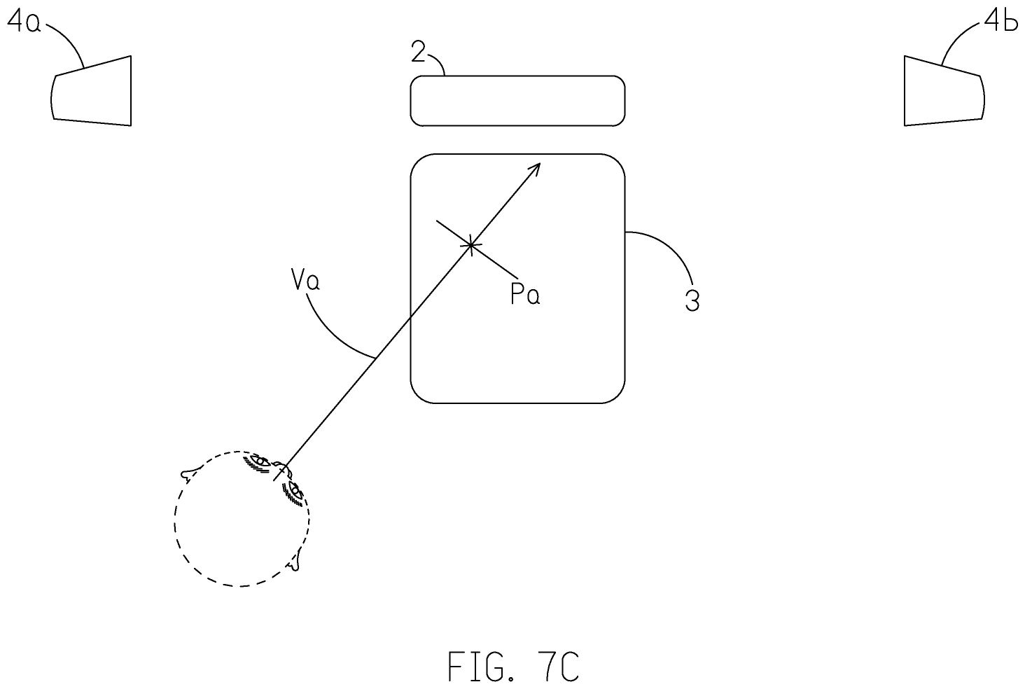

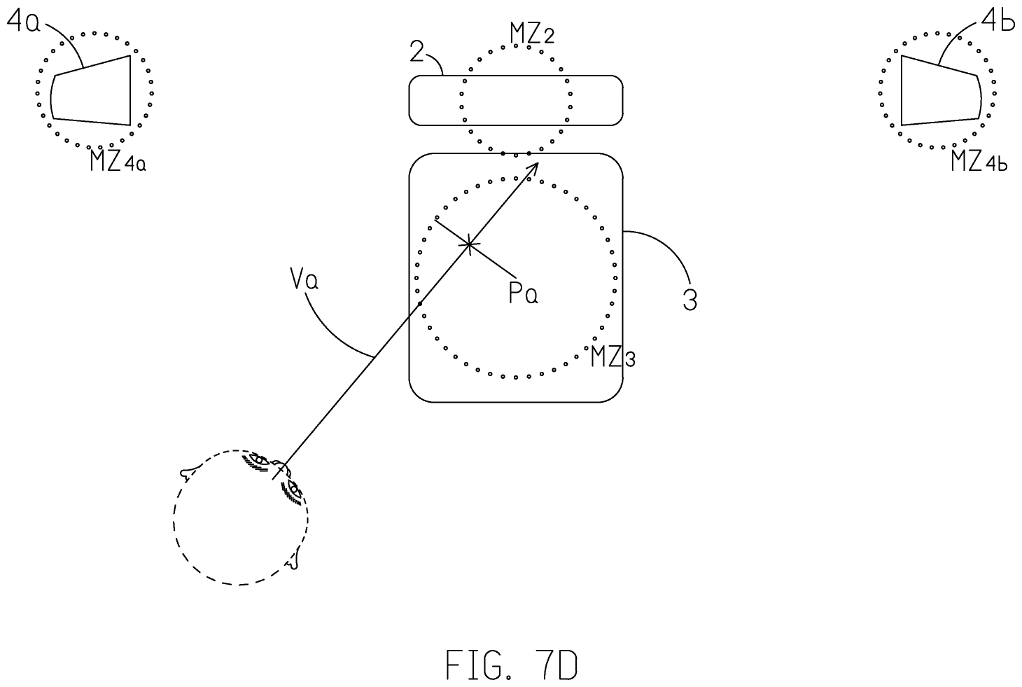

FIGS. 7A-7D are schematic diagrams illustrating an implementation where a user in a vehicle tries to control the facilities inside the vehicle through the control system 100. As shown in FIG. 7A, the facilities include an air conditioner 2, an infotainment system 3, a left rearview mirror 4a, and a right rearview mirror 4b. As disclosed, the locations/coordinates of the facilities are known and recorded by the control system 100. It should be noted that the four facilities are mentioned here for illustrative purposes only. There could be facilities of other types, such as wipers, sunroofs. that can also be controlled through the arrangement of the control system 100.

As illustrated in FIG. 7B, assuming the user (i.e. driver) is driving concentratedly and is looking forward; that is, the gaze vector V0 indicates that the gaze point P0 is on somewhere ahead rather than any of the facilities. If the driver now wants to play the next soundtrack of the album by the infotainment system 3, he/she would turn his/her gaze toward the infotainment system 3. Such change of the gaze is captured by the image capturing unit 10. As illustrated in FIG. 7C, the gaze vector Va is calculated in view of the world coordinate system. Based on the known positions of the driver and the facilities, the processing unit 14 estimates the current gaze point Pa based on the current gaze vector Va. Once the gaze point Pa is obtained, the processing unit 14 can then determine whether the gaze point Pa is on the infotainment system 3.

Optionally, each of the facility may have an operational zone upon which the processing unit 14 can determine whether a facility is subject to the user's control. In one embodiment, as depicted in FIG. 7D, assuming the corresponding operational zones for the facilities are MZ2, MZ3, MZ4a and MZ4b respectively. The operational zones in the instant example may be defined by one or more of the manners described above.

Assuming it is concluded that the gaze point Pa is on the infotainment system 3 or within the operational zone MZ3, the processing unit 14 issues a state of service to change the configurations of the input interface 12 or the processing unit 14 to accommodate the functions of the infotainment system 3. Subsequently, the user can exercise the input interface 12 arranged nearby to control the infotainment system 3, e.g. change the soundtracks, and/or increase or reduce the volume. As discussed, the input interface 12 may be a set of buttons/switches arranged somewhere nearby the user. In the previous example, the user may change the soundtrack displaying on the infotainment system 3 by, for instance, pressing the corresponding button/switch. Alternatively, if the input interface 12 is coupled to a standalone controller, the user will also be able to change the soundtrack and/or cast contents to the infotainment system 3 through the standalone controller provided a communication link has been established.

As disclosed, based on the nature of the facility subject to operate, the processing unit 14 of the control system 100 issues a state of service to configure the input interface 12 to accommodate the facility. For instance, the control signals of the infotainment system 3 may include change the channel, turn on/off the volume, streaming a music, etc. Similarly, if the control is made to the left rearview mirror 4, the configurations should be able to adjust the positions of the left rearview mirror 4. On the other hand, if the control is to the air conditioner 2, the control signals may include turn on/off, increase/decrease the indoor temperature, etc. In either case, the configurations should be able to accommodate the various functions and therefore to control different types of facilities.

It should be noted that in the FIGS. 7B-7D, the user's gaze vector (e.g., Va) is relied upon to infer the gaze point (e.g., Pa) and/or the target facility subject to control. However, as disclosed above, the gaze point may also be inferred by reference to other facial features such as the user's eye vectors, head pose, and facial landmark (e.g., nose tip). The adoption of the gaze vector is a mere example and should not become a limitation to the present invention.

It should be noted that in some cases, probably because the facilities are too close or because the operational zones are not well defined, there is a chance that the user's current gaze point may be inferred on more than one facilities, and thus may cause a confusion as to what exactly the facility is subject to control.

To resolve the issue, a probability correlation level between the gaze point and the facilities may be employed to determine the target facility. To be precise, the correlation is characterized by a probability distribution value, in which a closer distance between the gaze point and the facility operation zone will result in higher probability. Alternatively, the user's confirmation may be used to help defining the facility subject to control. For instance, when a confirmation signal made by the user is received from the input interface 12, the processing unit 14 configures the target facility as the facility subject to control. In another instance, when the user stares at the target facility more than a period of time (e.g., 2 seconds), the target facility is confirmed to be the facility subject to control. In some other instances, a facial gesture of the user is used as a confirmation of the target facility. After the confirmation, the user may take control over the facility. In this case, even when the user looks away from the confirmed target facility, the user may still be able to control the facility via the input interface 12. In other words, the driver doesn't need to look at the facility to make commands, the driver could keep his/her eyes on the road while driving and make commands to the facility at the same time and thus reduce the distraction. Therefore, the present disclosure provides a convenient and safer way for the driver to control multiple facilities.

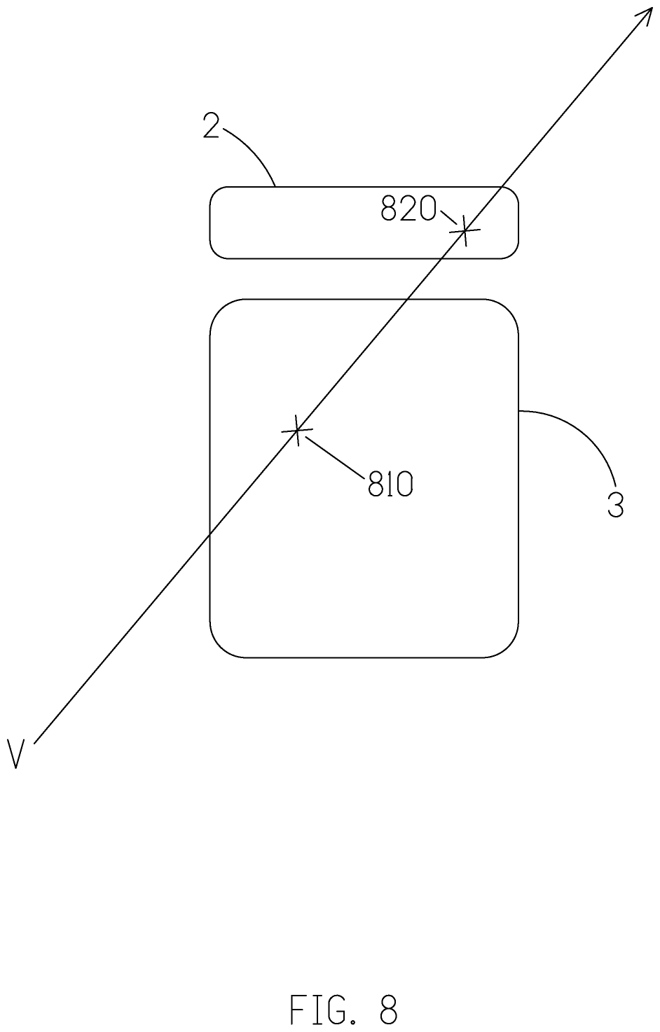

Alternatively, a point of interest may be used to define the facility subject to control. The point of interest differs than the gaze point is that the point of interests is a conclusion of feature behaviors from the continuous image frames and patterns. In one implementation, the point of interest is represented by a probability model, which will be established to determine which facility, more probable than not, that the user would like to control. The probability model may be determined based on various factors, such as, a gaze point of the user, a position of the user, positions of the facilities, a z-depth, a nature of the facility, and a user's preference (e.g., the user's habit or previous behaviors). The model is preloaded into the control system 100 for determining the point of interest. Through some sorts of deep-learning, machine learning or similar techniques familiar by the skilled persons, the point of interest could be estimated. Following the above example and as shown in FIG. 8, assuming the air conditioner 2 and infotainment system 3 are too close so that it may occur that the user's gaze point (calculated based on the gaze vector V) may be on or near the edge of both of the facilities (e.g., 810 and 820). So, without the mechanism to determine which facility shall prevail, the control made through the input interface 12 would not work properly. If, on the other hand, it is determined that, under such condition, the user is more likely staring at the air conditioner 2, the processing unit 14 issues a state of service signal to change the configurations of the input interface 12 so that the user can control the air conditioner 2. Alternatively, the control system 100 may adjust the way in which operational zones are defined to utterly avoid overlapped. In one example, as discussed previously, an operation zone may be defined by the contour of the facility. Under such circumstance, the overlap issue may not occur.

Sometimes a facility may take a while to initiate before it can actually be controlled. Under such circumstance, the user may have to wait for the initiation. To shorten the latency, the processing unit 14 may predict in what direction that the user would be looking toward and therefore prepare/pre-initiate the facilities alongside with the predictive path before the user stares at them. For instance, the processing unit 14 predicts a gaze trajectory according to a variation of the facial feature, such as the on-going positional change of the user's eyes and/or head pose, and maybe the user's previous habits.

In another embodiment, the processing unit 14 may predict a facility subject to control according to various factors, for example, the vehicle's status, the point of interest, and the user's preference. For instance, if the user tends to adjust the right rearview mirror after an adjustment to the left rearview mirror. The processing unit 14 anticipates the tendency and prepares the right rearview mirror while the user is adjusting the left rearview mirror. In this way, the latency would be reduced. Furthermore, the processing unit 14 initiate the infotainment system since it is estimated as the point of interest, or when the vehicle stops.

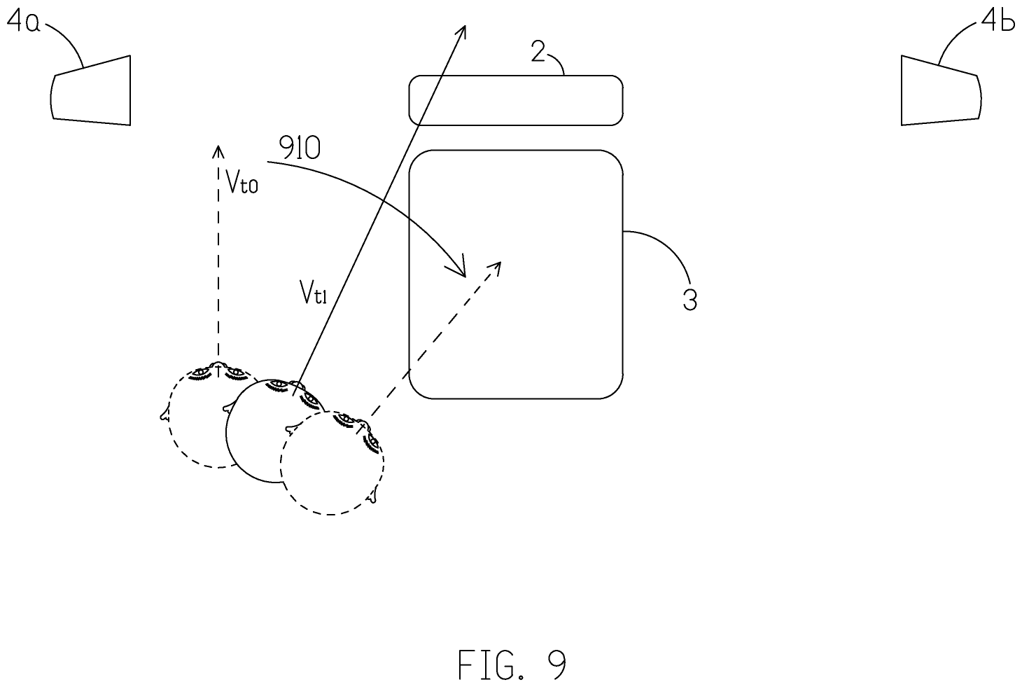

In some embodiment, the control system 100 pre-initiate one of the facilities beforehand. FIG. 9 is a schematic diagram illustrating a predictive path inferred based on the user's on-going positional/directional change of gaze. As disclosed above, the image capturing unit 10 captures the user's facial images continuously so that control system 100 can track the movement of the user's gaze. Based on the movement, a gaze trajectory (e.g., 910) is predicted in what direction or facility the user will be looking toward and prepare the facilities alongside with the predicted path. For instance, as shown in FIG. 9, assuming the control system 100 determines that the gaze vector of the user is moving right from the original Vₜ₀ to the current direction Vₜ₁. In other word, the user is now staring at the air conditioner 2 and thus the air conditioner 2 is under control. Based on the on-going positional/directional change, it is therefore predicted that the user tends to look toward the down-right side. Thus, the control system 100 would then prepare all the facilities alongside the predicted path (e.g., gaze trajectory 910). In the instant example, the facility to be pre-initiated is the infotainment system 3. By predicting what facilities that the user may be looking at and preparing them beforehand, the latency can be reduced.

It should however be noted that just because some facilities are pre-initiated, it does not mean that they will ultimately be controlled by the user. Under the design of the present disclosure, it is only when the user's gaze point falls on a target facility (i.e. the user actually stares at the target facility) that a control through the input interface 12 can be made to it.

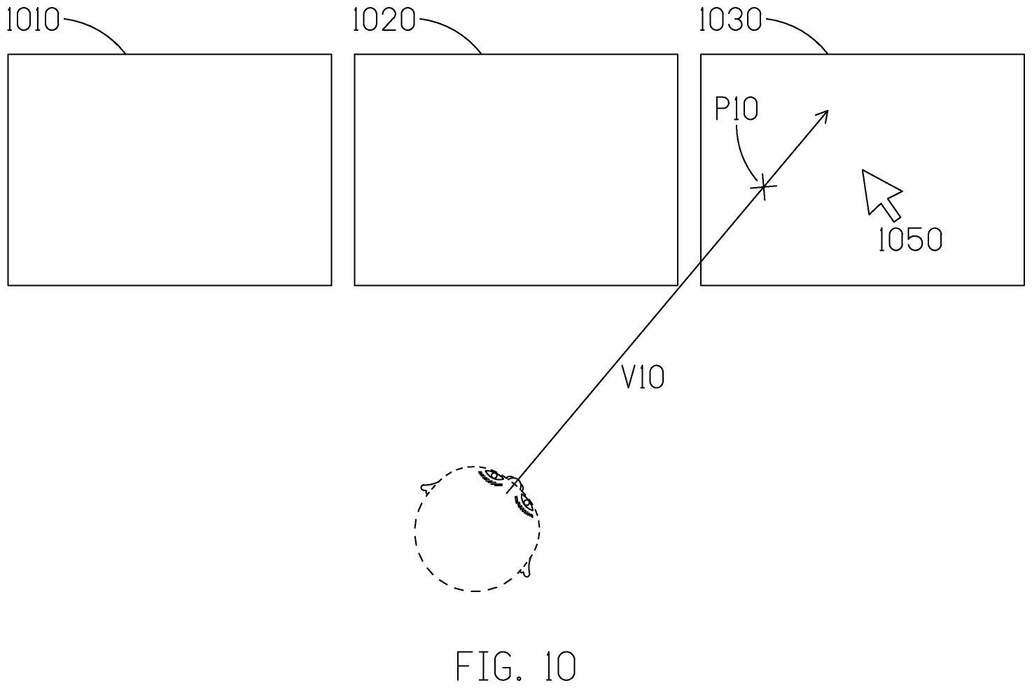

In some embodiments, to better understand what facility is being controlled, an indicator, such as a LED, may be disposed on each of the facilities to show the status. In a further example, the LED may have different colors to indicate the status of a facility. For example, the facility is inactive (i.e. not subject to control), the facility is currently under the user's control through the input interface 12, and the facility is initiated and ready to be controlled by the user when the user stares at it. In yet another example, if multiple displays are operated, a cursor, for instance, may appear on the display subject to control so that the user will understand he/she is controlling which display. FIG. 10 illustrates a scenario where multiple displays are controlled according to an implementation of the present disclosure. In this implementation, three displays (e.g., 1010, 1020, and 1030) may be subject to control by the user. Assuming it is determined that the user's gaze point P10 (along the gaze vector V10) is on the display device 1030, a cursor (e.g., 1050) appears on the display device 1030. Although three display devices are depicted in the instant example, the skilled persons should understand any number of display devices can also work under the arrangement of the present disclosure. Further, it should also be noted the cursor is a mere example to notify the user which facility/display he/she is controlling now. Any indicator, for instance, a letter, a light showing on the display frame with various colors, or other highlight patterns may serve the same purpose and should therefore be included in the scope of the disclosure.

In some embodiments, there could be many people in the same space want to control the facilities. Assuming the control system 100 is installed in a vehicle, either the driver or the passenger(s), may attempt to control/adjust the facilities. As a result, it is important to know who has the authority and the priority to command. Moreover, since there could be other standalone controllers capable of controlling the facilities, the control system 100 should also be able to distinguish the dominating controller over the others. In one embodiment, the control system 100 may provide a log-in service to verify users. The verification may be conducted through, for example, facial recognition. For instance, a user may be required to register his/her face IDs before he/she can command the facilities through the control system 100. The face ID may be stored in a storage of the control system 100. Since there can be more than one user whose face IDs are registered, the control system 100 may further prioritize the registered users.

In a scenario, a user may engage the control system 100 by, for example, appearing in front of the image capturing unit 10, the image capturing unit 10 captures the user's facial features to obtain his/her face ID, and then the processing unit 14 verifies if the user is one of the registered users by comparing the face ID against the data stored in the storage. If the face ID is verified, the user can command the facilities connected to the control system 100 through the operations of the input interface 12. Unless and until the user exits the control system 100, he/she is the super user dominating all the controls through the control system 100. Alternatively, a user may log in to the control system 100 through his/her own mobile device which has been registered to the control system 100.

In another occasion, if, for example, a driver and a passenger in a vehicle are both registered users and are both attempting to control the connected devices. In this instance, depending on the ranking, the control system 100 will determine who, either the driver or the passenger, has the priority over the other. Once decided, the facilities connected to the control system 100 are subject to the super user's command. In the same manner, only the standalone controller holding by the super user can be used to control/adjust the subject facility. The control system 100 may recognize the standalone controller by some sort of biometric data, e.g. face ID, also stored therein.

There are many ways to authenticate a user identity; facial recognition is a mere example to explain how the authentication can be achieved. It should however under no circumstance become a limitation to the present invention.

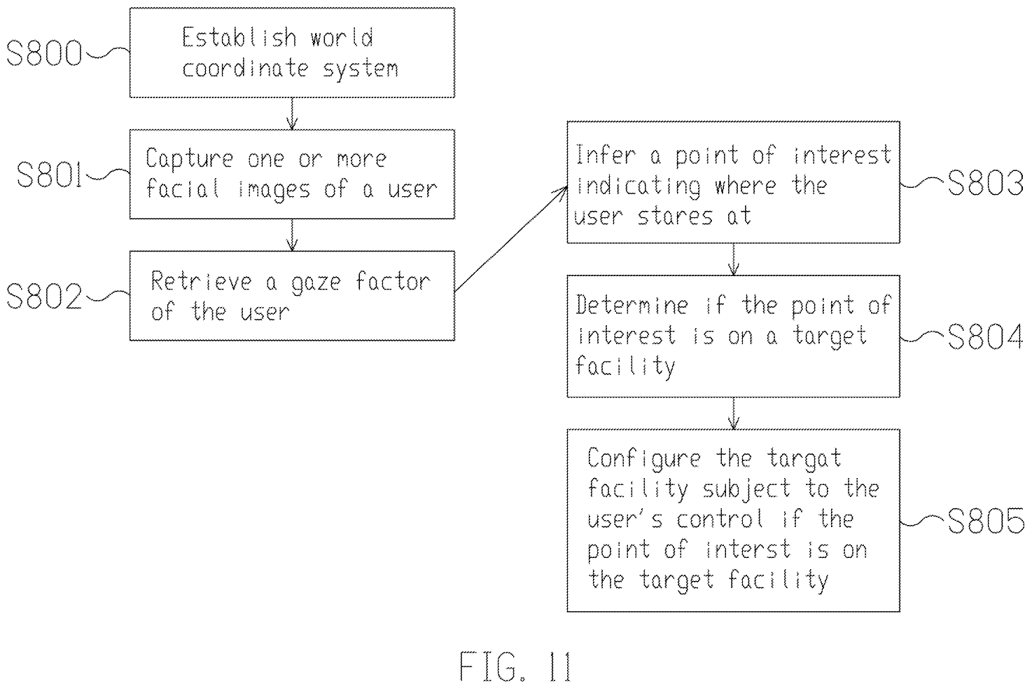

FIG. 11 illustrates a flowchart of a method for controlling multiple facilities according to an embodiment of the present disclosure. As shown, a method is provided for assisting a user to control facilities. The method includes the following actions. In action S800, a world coordinate system is established to indicate the positions of the user and the facilities. In action S801, one or more facial images of the user is captured. In action S802, a gaze vector of the user is retrieved from the captured image in view of the world coordinate system. In action S803, a point of interest indicating where the user stares at is inferred based on the gaze vector. In action S804, whether the point of interest is on a target facility is determined based on the coordinates of the facilities. And in action S805, the target facility is configured to be subject to the user's command if the point of interest is on the target facility.

As discussed previously, the control system is provided to control various types of the facilities. Thus, the method of the present disclosure further includes modifying the configurations of the input interface to accommodate to the functions of the target facility. Further, the determination of the gaze point may be based on the user's eye vectors, his/her head pose, and nose tip, etc. Besides, the method of the present disclosure may also include defining an operational zone to each of the facilities and determining if the gaze point falls within any of the operational zones to conclude the target facility. Additionally, the method of the present disclosure may further include notifying the user through an indicator indicating that the target facility is subject to control.

Apart from the above, the method of the present disclosure may further include predicting a predictive path indicating the direction where the user would be looking toward and pre-initiating the facilities alongside with the predictive path. The predictive path may be obtained given the on-going positional/directions changes of the user's eyes and/or head pose, and the user's previous behavior.

Last but not least, the method of the present disclosure may also include requesting users to register and consequently log in to the system; and prioritizing the registered users to determine whose control over the facilities dominates.

In summary, the proposed invention could reduce the distraction and simplify the procedures that a user may have when it comes to operate facilities. Embodiments of the invention may include various operations as set for the above or fewer operations or operations in an order that is different from the order described. The operations may be embodied in machine-executable instructions that cause a general-purpose or special-purpose processor to perform certain operations. That is, the techniques may be carried out in a computer system or other data processing system in response to its processor, such as a microprocessor, executing sequences of instructions. Such as a computer program may be stored or transmitted in a machine-readable medium. A machine-readable medium includes any mechanism that provides (i.e. store, and/or transmits) information in a form accessible through a machine (e.g., a computer, network device, personal digital assistant, and processors). For example, a machine-readable medium includes recordable/non-recordable media such as, but not limited to, a machine-readable storage medium (e.g. any type of disk including floppy disks, optical disks, CD-ROMs, and magnetic-optical disks, read-only memories (ROMs), random access memories (RAMs), EPROMs, EEPROMs, flash memory, magnetic or optical cards, or any type of media suitable for storing electronic instructions), or a machine-readable transmission medium such as, but not limited to, any type of electrical, optical acoustical or other form of propagated signals (e.g. carrier waves, infrared signals, digital signals).

Modifications, additions, or omissions may be made to the systems, apparatuses, and methods described herein without departing from the scope of the disclosure. For example, the component of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Based on the above, several control systems and methods for controlling multiple facilities, and vehicles having a control system are provided in the present disclosure. The implementations shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A control system, comprising:
an image capturing unit configured to capture a plurality of images of a user;
an input interface configured to receive an input signal from the user;
a processing unit coupled to the image capturing unit and the input interface, and configured to perform instructions for:
identifying a facial feature from the captured images;
inferring a gaze point of the user according to the facial feature;
determining a target facility among multiple facilities according to the gaze point of the user;
receiving a confirmation signal;
configuring the target facility as a facility subject to control when the confirmation signal is received; and
controlling the facility subject to control in response to a control signal received from the input interface.

2. The control system of claim 1, wherein the processing unit is further configured to perform instructions for:
obtaining a position of the user according to captured images;
obtaining positions of the facilities; and
determining the target facility according to the gaze point of the user, the position of the user and the positions of the facilities.

3. The control system of claim 2, wherein the processing unit is further configured to perform instructions for:
estimating a point of interest according to the gaze point of the user, the position of the user, the positions of the facilities and a user's preference; and
determining the target facility according to the point of interest.

4. The display system of claim 1, wherein the processing unit is further configured to perform instructions for:
predicting a gaze trajectory according to a variation of the facial feature;
determining a predicted facility according to the gaze trajectory; and
initiating the predicted facility.

5. The display system of claim 3, wherein the processing unit is further configured to perform instructions for:
determining a predicted facility according to the point of interest; and
initiating the predicted facility.

6. The display system of claim 2, wherein each facility has an operational zone, and the processing unit is further configured to perform instructions for:
inferring the gaze point of the user according to a gaze vector and the position of the user; and
determining whether the gaze point falls within one of the operational zone;
wherein when the gaze point falls within the one of the operational zone, the facility having the operational zone corresponding to the gaze point is determined as the target facility.

7. The display system of claim 1, wherein each facility has an operational zone, and the processing unit is further configured to perform instructions for:
providing an indicator indicating the facility subject to control.

8. A method for controlling multiple facilities, comprising:
capturing, by an image capturing unit, a plurality of images of a user;
identifying, by a processing unit, a facial feature from the captured images;
inferring, by the processing unit, a gaze point of the user according to the facial feature;
determining, by the processing unit, a target facility among the facilities according to the gaze point of the user;
receiving, by the processing unit, a confirmation signal;
configuring, by the processing unit, the target facility as a facility subject to control when the confirmation signal is received; and
controlling, by the processing unit, the facility subject to control in response to a control signal received from an input interface.

9. The method of claim 8, wherein the step of determining the target facility further comprises:
obtaining, by the processing unit, a position of the user according to captured images;
obtaining, by the processing unit, positions of the facilities; and
determining, by the processing unit, the target facility according to the gaze point of the user, the position of the user and the positions of the facilities.

10. The method of claim 9, wherein the step of determining the target facility further comprises:
estimating, by the processing unit, a point of interest according to the gaze point of the user, the position of the user, the positions of the facilities and a user's c; and
determining, by the processing unit, the target facility according to the point of interest.

11. The method of claim 8, further comprising:
predicting, by the processing unit, a gaze trajectory according to a variation of the facial feature;
determining, by the processing unit, a predicted facility according to the gaze trajectory; and
initiating, by the processing unit, the predicted facility.

12. The method of claim 10, further comprising:
determining, by the processing unit, a predicted facility according to the point of interest; and
initiating, by the processing unit, the predicted facility.

13. The method of claim 9, wherein each facility has an operational zone, and the method further comprising:
inferring, by the processing unit, the gaze point of the user according to a gaze vector and the position of the user; and
determining, by the processing unit, whether the gaze point falls within one of the operational zone;
wherein when the gaze point falls within the one of the operational zone, the facility having the operational zone corresponding to the gaze point is determined as the target facility.

14. The method of claim 9, wherein each facility has an operational zone, and the method further comprising:
providing, by the processing unit, an indicator indicating the facility subject to control.

15. A vehicle, comprising:
multiple facilities;
a control system comprising:
an image capturing unit configured to capture a plurality of images of a user;
an input interface configured to receive an input signal from the user;
a processing unit coupled to the image capturing unit and the input interface, and configured to perform instructions for:
identifying a facial feature from the captured images;
inferring a gaze point of the user according to the facial feature;
determining a target facility among the facilities according to the gaze point of the user;
receiving a confirmation signal;
configuring the target facility as a facility subject to control when the confirmation signal is received; and
controlling the facility subject to control in response to a control signal received from the input interface.

16. The vehicle of claim 15, wherein the processing unit is further configured to perform instructions for:
obtaining a position of the user according to captured images;
obtaining positions of the facilities; and
determining the target facility according to the gaze point of the user, the position of the user and the positions of the facilities.

17. The vehicle of claim 16, wherein the processing unit is further configured to perform instructions for:
estimating a point of interest according to the gaze point of the user, the position of the user, the positions of the facilities and a user's preference; and
determining the target facility according to the point of interest.

18. The vehicle of claim 15, wherein the processing unit is further configured to perform instructions for:
predicting a gaze trajectory according to a variation of the facial feature;
determining a predicted facility according to the gaze trajectory; and
initiating the predicted facility.

19. The vehicle of claim 17, wherein the processing unit is further configured to perform instructions for:
determining a predicted facility according to the point of interest; and
initiating the predicted facility.

20. The vehicle of claim 16, wherein each facility has an operational zone, and the processing unit is further configured to perform instructions for:
inferring the gaze point of the user according to a gaze vector and the position of the user; and
determining whether the gaze point falls within one of the operational zone;
wherein when the gaze point falls within the one of the operational zone, the facility having the operational zone corresponding to the gaze point is determined as the target facility.
